(19) United States
(12) Patent Application Publication
(10) Pub. No.: US 2002/0107016 A1
(43) Pub. Date: Aug. 8, 2002

(54) Communication system for automatic identification and electronic purchasing of broadcast contents

(76) Inventor: Richard R. Hanley, Cranbury, NJ (US)

Correspondence Address: OSTROLENK FABER GERB & SOFFEN, 1180 AVENUE OF THE AMERICAS, NEW YORK, NY, 100368403

(21) Appl. No.: 10/066,928

(22) Filed: Feb. 4, 2002

Related U.S. Application Data
(60) Provisional application No. 60/266,546, filed on Feb. 5, 2001.

(51) Int. Cl. H04Q 7/20

(52) U.S. Cl. 455/426; 455/3.05; 455/422

(57) ABSTRACT

A communication system for electronic purchasing contents received by transmission of broadcast communication and encoded with unique information identifying the contents includes a content code interpreter operative to decode the coded information and to transmit the decoded information to an order fulfillment center.

### CROSS REFERENCE TO RELATED APPLICATION

This application claims the benefit and priority of U.S. Provisional Application No. 60/266,546 filed Feb. 5, 2001 and entitled “Automatic Identification of Broadcast Content And Capability of Fully Electronic Purchase of That Content”, and which is incorporated herein by reference.

### FIELD OF THE INVENTION

The present invention relates in general to a communication system for automatically identifying content in broadcasts from all forms of media independent of, and without need of, any knowledge of the broadcaster, or station, or channel. Particularly, the inventive communication system enables consumers to automatically order and purchase standard, off-the-shelf content formats including CDs, movies, TV shows and advertised products and/or custom content formats.

### BACKGROUND OF THE INVENTION

Consumers often hear or see content in public broadcasts that they would order at that moment i.e., in realtime, if it could be done with the push of a few buttons. One of the desires of consumers is the ability to purchase individual songs playing on the radio that fit the mood of the moment. If the consumer can capture the music at that moment, in that particular environment, the consumer can have the ability to playback when the mood arises again or playback in an attempt to give rise or strength to a certain mood. Ideally, the consumer could accumulate songs to build a custom CD that could be mailed to their home, that could be picked up at a retail outlet or service center, or that could be downloaded to their home computer.

Several systems have been described to allow consumers to interact and place orders while they listen to or watch broadcast information. For example, U.S. Pat. No. 5,991,737 to Chen discloses a method for ordering publicly broadcast information. The system allows consumers to order this information without having to identify the content of the information and, more particularly, concerns automated purchasing of recordings of songs played over the radio, automated purchasing of various products advertised on radio, television, etc. Utilizing the disclosed system, the consumer can dial the radio station's ID number to order a copy of the content being presented at that time.

One of the disadvantages of the Chen system is that a centralized processing center must identify the content ordered by a consumer by performing a pattern recognition search in response to the consumer request. This, in turn, may prolong a process of identifying and ordering the desired broadcast material. In essence, in the Chen system, the content is identified only after the system determines what radio station the consumer was listening to and then uses information at a processing station to determine what the consumer wants. Thus, Chen identifies content at the processing center instead of directly based on identification information provided from the consumer location.

U.S. Pat. No. 5,539,635 to Larson, Jr. discloses a radio station program identifier and distribution system in which each participating broadcaster transmits program information to the system about each broadcasted program. The consumer requests desired musical programs by providing the time, date and broadcaster of the program that was heard on the radio. The system allows a customer to hear a preview of each requested program, choose programs broadcast temporally close to a requested time, choose from a menu programs similar to the requested program and select the radio station from a menu. The system creates a custom recording and ships it to the customer.

One of the disadvantages of the Larson system is that a consumer must contact a processing center and input the time, date and broadcaster for identifying content to be purchased. Accordingly, the Larson system, like the Chen system, may lead to a time-consuming ordering process.

It is, therefore, desirable to provide an automated communication system allowing a consumer to automatically identify broadcast information in a simple and time-efficient manner. Also, a communication system operative to fulfill an order, which is placed by the consumer, based on the identified information, is desirable as well.

### SUMMARY OF THE INVENTION

These goals are attained by an inventive system operative to decode information, which is embedded in broadcast information and identifies desirable content, at a consumer location and further to transmit from the consumer location a consumer order that contains the decoded information to a processing center for fulfillment of the order. The system combines three existing technologies, radio or other receiving device, cell phone or other wireless device and a presently existing technology such as ARIS which provides embedded information on broadcast signals identifying the songs, TV shows, movies or advertised materials that are broadcasted by the radio, TV, or downloaded on a PC.

In accordance with one aspect of the invention, the inventive system allows a consumer to order a song, a combination of songs or other material that is played or shown on the radio or TV or any other form of media while listening to or soon after the end of the broadcast. The inventive system can be used in the home or office or while driving an automobile or anyplace else. The inventive automated and closed system allows consumers to automatically identify and fully electronically purchase content in public broadcasts from all forms of media by, for example, depressing a button for sending a signal by means of wireless technology, for example, cell phone technology, to an order fulfillment center.

According to one aspect of the inventive system, it comprises a content code interpreter device including a transmitting and receiving mechanism and a tuning mechanism and is configured to read codes that can be inaudibly and invisibly embedded in the content of public broadcasts. Another feature of the inventive system includes the code interpreter which is operative to display descriptive information that has been decoded to identify content on an LED or other display device. This encoded/decoded information can include, but is not limited to, names of performers and titles of individual songs or entire CDs, publishing dates, as well as information concerning recording studios or manufacturing firms of advertised goods, TV shows and movies. The transmitting mechanism allows, at the push of a button, with no human intervention, the direct placement of orders to computers at the processing order fulfillment center. The rest is automatic. The order is transmitted by cellular telephone or other communication link for execution of the action indicated by the consumer, which can be keypunched or spoken into the content code interpreter by the consumer, to the processing order fulfillment center.

Thus, the inventive system allows the customer to build up a queue of songs by adding songs to the queue, as desired by manipulating an LED panel, or other display device, in conjunction with various buttons and switches. Accordingly, the consumer can use the device to immediately capture and store an instance of identified content, in the queue. Then, the system allows the customer to continue adding future instances of content that he or she would like to purchase with an option to delete any of the stored information, such as songs, or to change the order of songs as desired. One of several ways in which this process could be utilized is by creating a custom CD, DVD, tape or any other recording format where the consumer desires to identify and purchase two or more songs from different standard off-the-shelf CD's and/or artists. Once the desired number of songs has been identified, queued, categorized, and sorted, the consumer can depress a button to send the order by a cellular link or other communication link to a processing center. The user can, if desired, select only one song. Accordingly, the consumer can place an order immediately upon the identification of any given song or advertisement by the content code interpreter, or wait until a queue has been developed.

In accordance with yet another aspect of the invention, the inventive system is capable of automatically transmitting information concerning a consumer along with decoded information so as to enable time-efficient identification of the requesting consumer at a processing order fulfillment center.

In accordance with a further aspect of the invention, once the order has been received by the processing center, an acknowledgment is sent to the consumer, while an order is further transmitted electronically to a manufacturing location. Once manufactured, a CD is shipped to the consumer by mail or other delivery means which can be addressed to the consumer's home address or to a desirable retail outlet. Alternatively, the content can be downloaded to the customer's personal computer via the Internet.

It is, therefore, an object of the invention to provide a simple automatic system and method for purchasing in realtime content heard, seen, or otherwise experienced in or on public broadcasts from all forms of media.

Another object of the invention is to provide an automated communication system for identifying contents broadcasted by different types of media at a customer location.

Yet another object of the invention is to provide an automated communication system capable of executing an order by a customer in response to receiving the order and based upon the content identifying information.

Other features and advantages of the present invention will become apparent from the following description of the invention which refers to the accompanying drawings.

### BRIEF DESCRIPTION OF THE DRAWING(S)

FIG. 1 is a diagrammatic view of a communication system automatically identifying content heard, seen, or otherwise experienced in or on public broadcasts from all forms of media and capable of electronically placing an order to purchase a desirable material based on the identified information.

FIG. 2 is a block diagram of an entire broadcast content life cycle from origination to consumption in which content is publicly broadcast, is experienced by a consumer, is identified electronically, and can be purchased at the push of a button.

FIG. 3 is a flow chart of a communication system illustrating a method of processing decoded information transmitted by a consumer as well as processing information concerning the consumer.

FIG. 4 is a block diagram of a consumer device consisting of a code interpreter and a transmitting and receiving mechanism, configured to identify content for consumers and allow electronic management of the order process.

FIG. 5 is a block diagram of an order fulfillment center for automated processing of orders, automated initiation of fulfillment, and service.

FIG. 6 is a block diagram of an integrated unit that combines consumer receiver 16 and content code interpreter 18.

### SPECIFIC DESCRIPTION OF EMBODIMENTS OF THE INVENTION

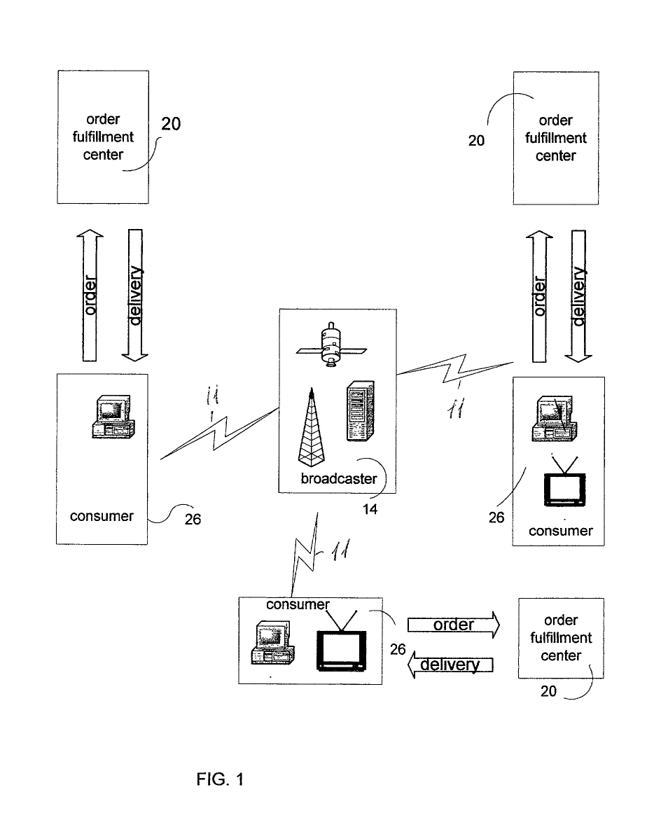

With reference now to the drawings and more particularly to FIGS. 1-3, a communication system in accordance with the invention allows receiving of broadcast content by any of numerous consumers 26 from a broadcaster 14 by utilizing a variety of communication links 11. Broadcaster 14 transmits video, or audio information, by wireless or wired means, for example, broadcaster 14 may be a radio or TV system or a cable transmitter, or any other broadcast content provider. Particularly, the consumer 26 is provided with a receiving device capable of identifying content of broadcasts and further with a transmitting device sending the identified information along with information concerning the consumer to an order fulfillment center 20 which may or may not be integrated with the broadcaster. In response to receiving such information, order fulfillment center 20 is operative to authenticate the consumer and to fulfill the order.

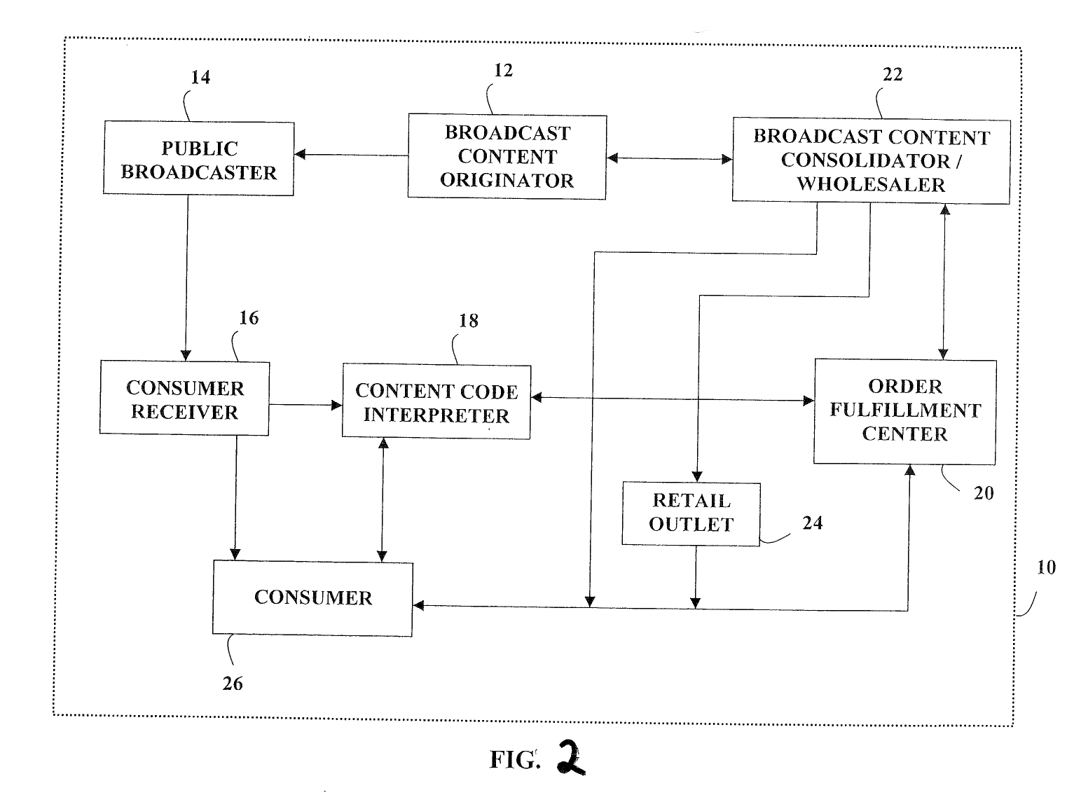

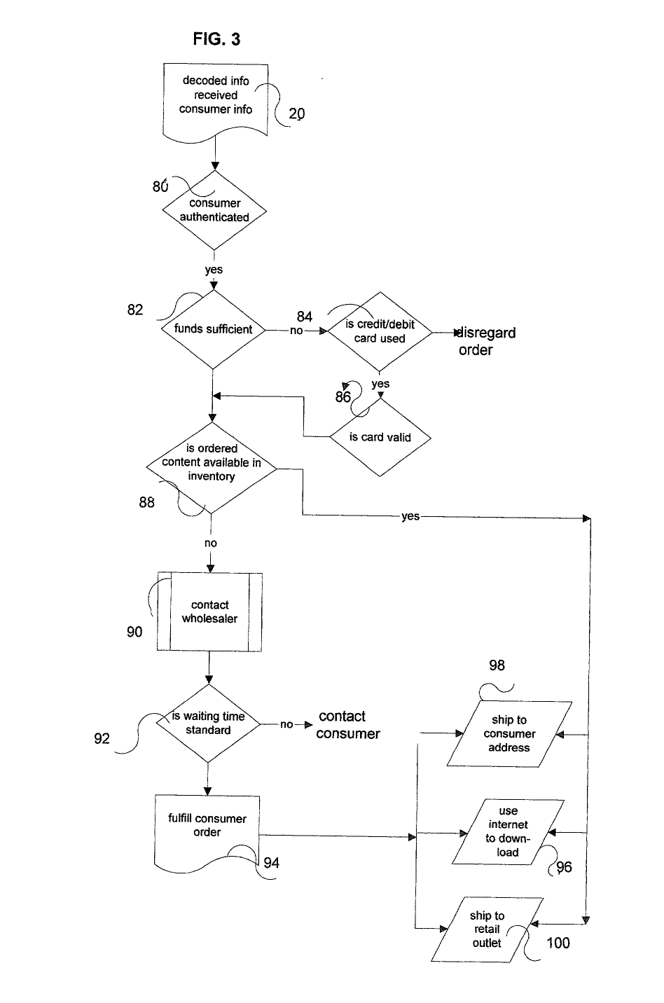

As particularly shown in FIGS. 2 and 3, broadcast content life cycle 10 includes broadcast content originator 12 (for example a movie or recording studio), public broadcaster 14 (for example, a TV or radio station), consumer receiver 16 (for example, a radio or TV), content code interpreter 18 (described in detail below), an order fulfillment center 20 (described in detail below), broadcast content consolidator/wholesaler 22 (described in detail below), retail outlet 24 (for example, a record store), and consumer 26.

Broadcast content originator 12 is either the originator of the content in a public broadcast or owns some or all of the rights to the content in a public broadcast. The broadcast content originator could be a recording artist or an agent or a studio (movie or recording). In any case, the broadcast content originator wants to sell certain content to consumers. To do so, public broadcaster 14 sends content over the airwaves or through wires to consumers. As shown in FIG. 1, the public broadcaster can be television stations, radio stations, satellites, and some locations on the world wide web known as the Internet. The public broadcaster takes the media content created and/or owned by broadcast content originator 12 and translates it into a form that is receivable by consumers over the airwaves or through wires.

Consumer receiver 16 is a device that receives signals transmitted by public broadcaster 14. Current examples include televisions (including cable and satellite television), radios, stereo tuners, personal computers, network computers, and cell phones. Content code interpreter 18 is configured to read codes that can be inaudibly and invisibly embedded in the content from all forms of media found in public broadcasts, for example, ARIS coding, which is already used by many audio transmitters to identify content. The content code interpreter is configured to display descriptive information on an LED or other display mechanism by decoding the transmitted codes. The consumer transmitting and receiving mechanism contained in the content code interpreter can make use of ordinary telephone lines, cellular or PCS technology (analog or digital), or wired or wireless Internet connections. The transmitter is programmed to contact the closest order fulfillment center. The content code interpreter can be a stand alone piece of equipment which can be used in connection with a radio and CD player and for those who do not have a radio or CD player, it can be combined with a radio or CD player device. Alternatively, it may be built into the receiving device. Further, such a device can be used in automobiles, in the home or office or elsewhere. Further, the device is not limited to radio transmissions, but can be used with any information transmission, e.g. television, that contains embedded information identifying the content.

Order fulfillment center 20 is configured to use computers to automate the receipt and processing of orders transmitted from the content code interpreter. Once software executing on the order processor computer has authenticated a requesting consumer optionally by verifying his PIN at 80 (FIG. 3), it further verifies the sufficiency of funds deposited on the consumer's account 82 provided that the consumer is a registered customer. Account information, which can indicate whether a certain sum of money is initially deposited by the consumer 26 and still available or that the consumer has the required credit as determined by a credit card account, for example, and other information for consumer 26 are established at the time that consumer 26 obtains the rights to use the content code interpreter, or anytime thereafter. Consumer 26 is given an account number, security codes, payment options, credit limits and other information required to use the invention for its intended use. A registering procedure can be accomplished by a variety of methods including the Internet.

If the consumer is found not to have sufficient funds, software executing on the order processor computer verifies if the consumer has used a credit/debit card at 84. Upon verifying validity of the credit/debit card and obtaining approval of a card issuer at 86, software is further utilized for determining if the decoded information identifies standard contents and, if this identification is positive, whether it is available in inventory at 88. Order fulfillment center 20 is configured to resolve all orders by various means, chiefly by checking inventory records for standard content and initiating the delivery sequence.

Provided that standard content is not available in inventory or custom content is ordered, software executing on the order process computer transmits the order to content wholesaler 22 which has its own electronic equipment provided with software that is operative to either locate the standard content or to build custom content at 90. Accordingly, broadcast content consolidator/wholesaler 22 is an entity that facilitates the procurement, mixing, or creation of standard and custom audio recordings, video recordings, and other forms of content. Broadcast content consolidator/wholesaler 22 works with broadcast content originator 12 (FIG. 2) and order fulfillment center 20 to fulfill orders. Broadcast consolidator/wholesaler 22 electronically updates order status on the order fulfillment center computers and coordinates with order fulfillment center 20 the execution of delivery to consumer 26. Also, this entity negotiates and maintains the contracts that allow the combination of content from multiple content originators. In addition to the above-described functions, the consolidator/wholesaler can have software executing on its computer for determining if the placed order would take an unusually long time for delivery at 92 due to special situations such as backorders. If this time is estimated to exceed certain standard, the wholesaler contacts order fulfillment center 20 which automatically advises consumer 26 on a schedule using the communication means indicated in the account information by consumer 26. Furthermore, software executing on the wholesaler computer is capable of real-time tracking of orders and inventory. If the estimated time is rather standard, the computerized equipment is operative to provide delivery in accordance with a preferred method indicated by the registered customer during a registration procedure. Alternatively, the consumer can specifically indicate a preferred method of delivery by providing additional information along with his/her order. The consumer may request that the order be downloaded on the consumer's PC at 96, or shipped directly to his/her home address at 98, or mailed to a predetermined retail outlet 24 at 100. The fulfillment center 20 is also configured to have software executing on the computers for enhancing the consumer's experience by analyzing consumers' complaints and suggestions which are typically addressed to and stored in the computerized service center.

In operation of broadcast content life cycle 10, broadcast content originator 12 provides broadcast content to public broadcaster 14 which broadcasts it to consumer 26 by transmitting to consumer receiver 16 along with content identifying code information, such as provided by ARIS. If consumer 26 wishes to order, or otherwise respond, the consumer uses content code interpreter 18, which identifies the content, to organize and place orders or to transmit other responses. Content code interpreter 18 identifies broadcast content by deciphering the embedded codes (such as ARIS codes) and allows automated, electronic placement of orders based on the decoded information to order fulfillment center 20. Also, optionally to indicate a type of action to be fulfilled, such as a tape recording or a CD recording as well as a method of delivery, consumer 26 can keypunch or speak into the content code interpreter while placing the order, unless such an action is specified in a contract.

With reference to FIG. 4, content code interpreter 18 includes code interpreter 28 and transmitting and receiving mechanism 30. Code interpreter 28 identifies content by reading codes that are inaudibly and invisibly embedded in broadcast content. Transmitting and receiving mechanism 30 is configured to allow fully electronic communication with order fulfillment center 20. The transmission could be partially initiated by spoken word if voice recognition software is used but it is transmitted electronically.

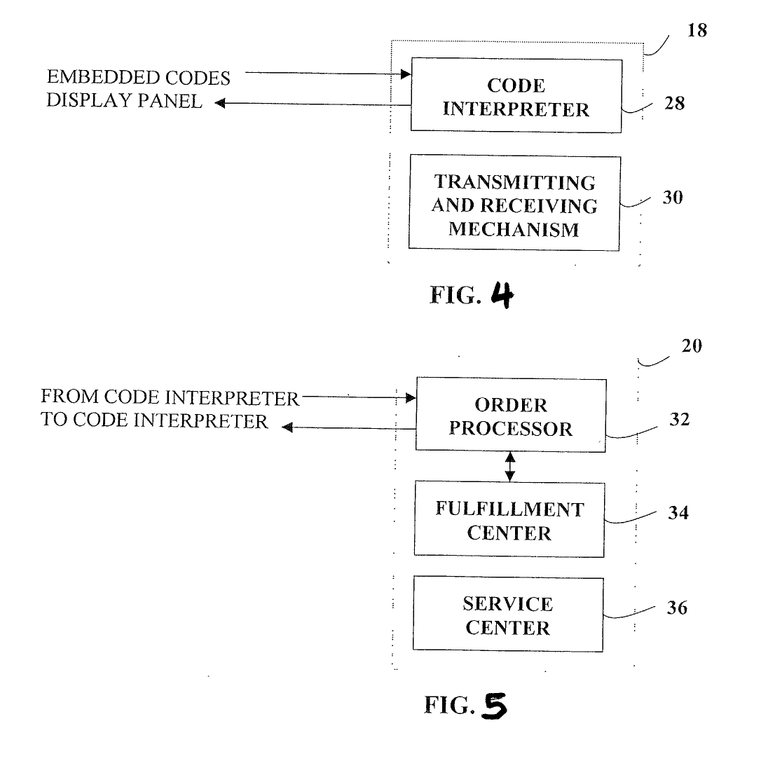

With reference to FIG. 5, order fulfillment center 20 includes order processor 32, fulfillment center 34, and service center 36. Order processor 32 is connected to fulfillment center 34 computers and to broadcast content consolidator/wholesaler 22. Fulfillment center 34 computers contain account information for consumer 26. Service center 36 takes care of consumer 26 where there is any issue that must be handled by human intervention.

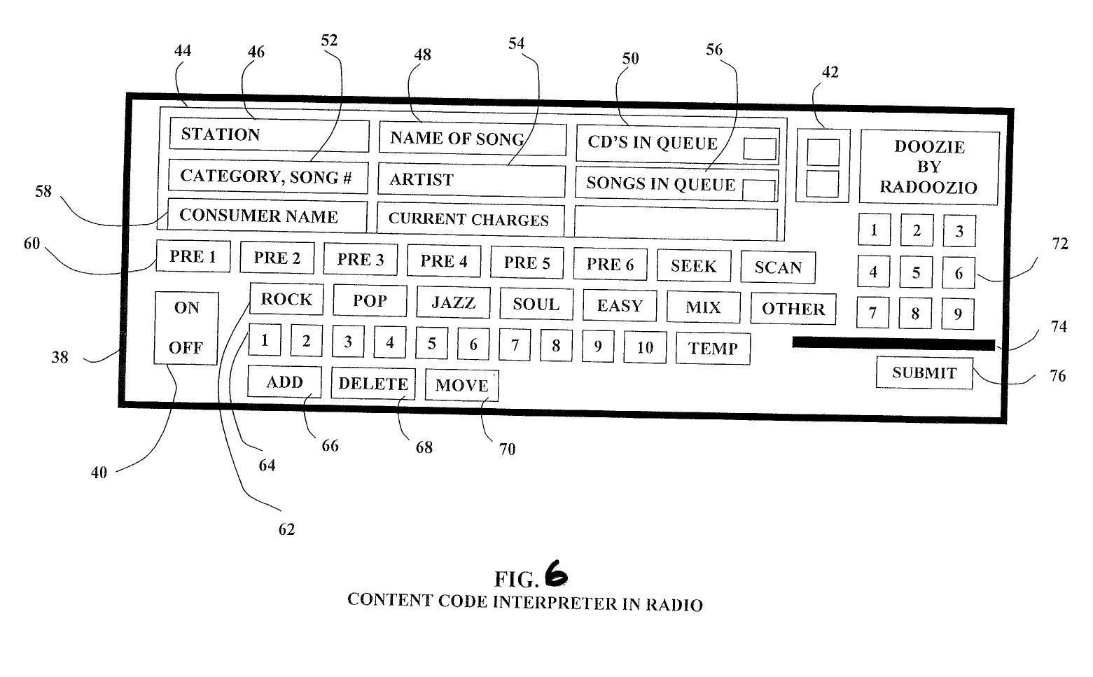

FIG. 6 shows an example of the invention in which consumer receiver 16 and content code interpreter 18 are a fully integrated unit. It combines the features and functionality of a radio with the features and functionality of the content code interpreter. Consumer 26 uses power button 40 and signal strength indicator 42 to power on and off content code interpreter in radio 38 and to monitor that the signal is sufficient to enable sufficient fidelity and readability for the content code interpreter device. The content code interpreter signal light slowly flashes red if the content codes cannot be read or do not exist. The consumer selects a broadcast station by using pre-sets or seek and scan actuators 60. When the consumer hears content that he or she would like to purchase, consumer 26 can read the identification of the musical content, as well as other information about the musical content, on LED panel or other display 44. Alternatively, consumer 26 can proceed to place an order without ever reading the identification material displayed on the LED or other display mechanism.

To build a custom CD for a given category of music, such as rock or jazz, consumer 26 starts by pushing one of the category 62 buttons. Next, consumer 26 can select a song number to position the song on the CD using song position 64 buttons. Choosing the number 3 means that the song will be number 3 on the given CD being built for the category of music that has been chosen. Then consumer 26 pushes add song button 66 to include the selection in the current order queue.

If consumer 26 wishes to delete a song from the order queue, he or she chooses the category and song by pushing buttons until the song identifier appears on the LED or other display. Then consumer 26 pushes the delete song button 68.

If consumer 26 wishes to move a song, from one position to another on the CD, while there are still numbers without a song assigned to them, he or she starts by pushing the appropriate song position 64 button for the song or content to be moved. Then by depressing move button 70 and by manipulating the song position button 64 for the new position, the consumer, finally, pushes the add song button 66 to place the song in a desirable position.

If consumer 26 wishes to move a song or other content, from one position to another on the CD or DVD, when there are no numbers without content assigned to them, the consumer starts by pushing the appropriate song or other content position button 64 for the song to be moved. Hereinafter, the content will be identified as a “song”, but the content can be any content. Then the consumer has to push move button 70, push the song position button 64 for the Temp position, and pushed the add song button 66. Then, by further manipulating song position button 64 for the song to go in a desirable place, the consumer operates move button 70, song position button 64 for the new position, and push the add song button 66. Finally, the consumer pushes the song position button 64 for the Temp position, pushes move button 70 and song position button 64 for the new position by punching add song button 66.

When consumer 26 is ready to submit an order for a particular CD in a chosen category, he or she pushes a category 62 button to select a category of music for review on the LED or other display panel or to go right to the order submission steps. Depending on the account set-up, consumer 26 inserts a Security Card or Credit Card or ATM Card into card slot 74. Then consumer 26 enters his or her PIN on keypad 72 or simply speak into the code interpreter provided with voice recognition software. Finally, consumer 26 pushes the submit button 76, thereby sending identified information concerning the content and information concerning the consumer to order fulfillment center 20.

Although the present invention has been described in relation to particular embodiments thereof, many other variations and modifications and other uses will become apparent to those skilled in the art. Therefore, the present invention should be limited not by the specific disclosure herein, but only by the appended claims.

What is claimed is:

1. A method for electronically ordering broadcast content for subsequent delivery thereof, comprising the steps of:
receiving a broadcast electronic transmission including coded information identifying the content of the broadcast transmission at a consumer location;
decoding the coded information identifying content at the consumer location; and
at consumer selection, automatically transmitting to an order fulfillment center an order for selected content based upon the decoded information which uniquely identifies the selected content.

2. The method defined in claim 1, wherein the coded information is embedded inaudibly and invisibly in the broadcast transmission, the decoded information being transmitted via a communication link from the consumer location to the order fulfillment center for fulfilling an order from a consumer.

3. The method defined in claim 2, wherein the communication link comprises one of a wireless communication network, wired communication network and a combination thereof.

4. The method defined in claim 2, wherein the order is transmitted immediately upon identifying the selected content.

5. The method defined in claim 1, wherein the decoded information is displayed at the consumer location before transmitting the decoded information to the order fulfillment center.

6. The method defined in claim 1, further comprising the steps of storing the decoded information at the consumer location, selecting at least other content by decoding and storing respective decoded information identifying the at least one other content, and transmitting the stored decoded information as a custom order to the order fulfillment center.

7. The method defined in claim 6, further comprising the step of selecting the order of the recordings of the at least one and other selected content, deleting any of the selected contents and changing the order of positioning before transmitting the custom order to the order fulfillment center.

8. The method defined in claim 6, further comprising the step of transferring the custom order to a broadcast content consolidator wholesaler to record the at least one and other selected content together.

9. The method defined in claim 4, wherein the decoded information of the at least one selected content represents a standard work, the method further comprising the steps of checking the inventory to determine availability of the standard work, and if the standard work is not available, contacting the broadcast content consolidator wholesaler.

10. The method defined in claim 1, further comprising the step of transmitting information concerning a method of recording of the at least one selected content comprising recording the selected work on one of a tape, CD, DVD and a combination of these along with the decoded information to the order fulfillment center.

11. The method defined in claim 1, further comprising the step of delivering the at least one selected content to the consumer upon receiving the order by one of delivering the selected content to a home address, delivering to a retail outlet, downloading it on a PC located at the consumer location or at a distance therefrom, and a combination of these.

12. The method defined in claim 1, further comprising the step of registering a consumer at the order fulfillment center such that the consumer is assigned a PIN for automatically authenticating the consumer transmitting the decoded information, and a consumer deposit account which is identified upon verification of the PIN, and the step of automatically charging the deposit account upon receiving the order.

13. The method defined in claim 1, further comprising the steps of displaying the decoded information at the consumer location.

14. The method defined in claim 1, where the step of receiving comprises receiving at a consumer location via a radio means apparatus in a mobile vehicle.

15. The method defined in claim 1, wherein the step of automatically transmitting comprises transmitting via a cellular communications link.

16. A system for electronically ordering selected content transmitted by broadcast transmission and embedded with coded information which identifies the content, for providing subsequent delivery of the content comprising:
a receiver located at a consumer location and operative to receive the transmitted content and coded information;
a content code interpreter coupled to the receiver and operative to decode the coded information of at least one selected content from the broadcast transmission, the content code interpreter being operative to transmit an order for the at least one selected content based on the decoded information to a fulfillment center spaced at a distance from the consumer location for fulfilling the order.

17. The system defined in claim 16, wherein the content code interpreter is a stand-alone unit or an integral part of the receiver, the receiver comprising one of a TV set, portable radio, automobile radio, stationary radio, PC and a combination thereof.

18. The system defined in claim 16, further comprising a display coupled to the content code interpreter and operative to display the decoded information of the at least one selected content transmitted via a communication link which comprises one of a wired communication network, wireless communication network and a combination thereof.

19. The system defined in claim 18, wherein the displayed decoded information comprises one of names of individual songs, CDs, radio shows, TV shows, names of performers, other information capable of identifying the at least one selected content and a combination thereof.

20. The system defined in claim 16, wherein the content code decoder interpreter operative to indicate whether the transmitted are being encoded.

21. The system defined in claim 16, wherein the content code interpreter is operative to store the encoded information identifying the at least one selected content, select another transmitted content, and decode coded information identifying the other selected content to build and manipulate order queues before transmitting the stored decoded information of the selected content to the order fulfillment center.

22. The system defined in claim 16, wherein the content code interpreter is operative to recognize the voice of the consumer identifying a method of delivery of a recorded copy of the selected content, the method of delivery comprising one of mailing the recorded copy to a home address of the consumer or to a retail outlet, and downloading the selected content on a PC via the Internet.

23. The system defined in claim 16, wherein the content code interpreter has a transmitting mechanism enabled by the consumer upon decoding of the coded information for transmitting the decoded information to the order fulfillment center.

24. The system defined in claim 16, wherein the order fulfillment center has a computerized system having software for checking whether the selected content contained in the received order are readily available based on the transmitted decoded information, and, if the selected content are not readily available, the computerized system has software for sending the order to a broadcast content consolidator/wholesaler which has a respective computerized system provided with software for recording the selected work based on the decoded information and with software for confirming the order.

25. The system defined in claim 24, wherein the computerized system of the order fulfillment center has software for registering consumers such that each consumer is assigned a respective PIN and account number associated with the PIN, the PIN being transmitted along with the decoded information.

26. The system defined in claim 16, wherein the content code interpreter is operative to transmit information concerning a security card or a credit/debit card and the PIN.

27. The system defined in claim 24, wherein the computerized system of the order fulfillment center has software for tracking the recording and delivery of the consumer order.

28. The system defined in claim 16, wherein the receiver comprises an automobile radio.

29. The system defined in claim 16, where the content code interpreter transmits the order to the fulfillment center via a cellular communication link.
